(19) United States
(12) Patent Application Publication
(10) Pub. No.: US 2009/0077015 A1
(43) Pub. Date: Mar. 19, 2009

(54) SYSTEM AND METHOD FOR IMPLEMENTING COMPOSITE APPLICATIONS

(76) Inventors: Douglas Coutts, Seattle, WA (US); Richards Federie, Seattle, WA (US); Michael Geyer, Seattle, WA (US); Scott Oyler, Seattle, WA (US)

Correspondence Address: PERKINS COIE LLP;PATENT-SEA, P.O. BOX 1247, SEATTLE, WA, 98111-1247, US

(21) Appl. No.: 12/125,023

(22) Filed: May 21, 2008

Related U.S. Application Data
(60) Provisional application No. 60/939,287, filed on May 21, 2007.

(51) Int. Cl. G06F 7/00; G06F 17/30

(52) U.S. Cl. 707/2; 707/E17.005; 707/E17.048

(57) ABSTRACT

A software and/or hardware facility for implementing composite applications. The facility includes a composite application designer that enables users to create and modify composite applications. A composite application can include data from primary assets, as well as data from derived assets, which are assets that are derived from one or more primary assets. The composite application designer also enables the creation of configuration files for configuring access to data corresponding to primary and derived assets. The facility also includes a data access service that enables access to data corresponding to primary and derived assets. The data access service is configured by a configuration file that is created by the composite application designer.

### CROSS-REFERENCE TO RELATED APPLICATION(S)

This application claims the priority of U.S. Provisional Application No. 60/939,287, entitled COMPOSITE ASSET DESIGNER, filed May 21, 2007, the entirety of which is hereby incorporated by reference.

### TECHNICAL FIELD

The present invention is directed generally toward implementing composite applications.

### BACKGROUND

Typically, a composite application is an application that takes functionality provided by disparate applications or data sources and provides it to users in a manner that is relevant to the users. Composite applications typically combine application and information assets drawn from multiple sources. In this context, assets are reusable components such as data sources, web services, or entire systems whose outputs have been packaged as web services (often legacy systems such as Enterprise Resource Planning (ERP), Customer Relationship Management (CRM) and Supply Chain Management (SCM) systems). Composite applications are typically web-based applications that are hosted by application servers.

One example of an application server that enables the development and delivery of composite applications is Microsoft Office SharePoint Server (MOSS), produced by Microsoft Corporation of Redmond, Wash. MOSS includes a search component that enables indexing and retrieval of data stored in MOSS or in external data sources. MOSS also includes a component that enables creation and manipulation of lists, a component that enables data capture and data validation, and a component that enables display of data from external data sources. However, it can be difficult to create and maintain consistent configuration files for the various components of a MOSS installation. Furthermore, while MOSS enables displaying data from external data sources, it is still difficult to write data to external data sources. Other application servers for composite applications suffer similar drawbacks.

Accordingly, systems and methods that overcome the above problems, as well as provide additional benefits, would have significant utility.

### BRIEF DESCRIPTION OF THE DRAWINGS

FIG. 1 is a block diagram that illustrates components of a facility for implementing composite applications.

FIG. 2 is a block diagram that illustrates a composite application designer component of the facility.

FIG. 3 is a flow diagram of a process implemented by the facility for creating a composite application.

FIGS. 4-12 are representative screenshots depicting interfaces implemented by the facility for creating a composite application.

FIG. 13 is a flow diagram of a process implemented by the facility for generating artifacts for a composite application.

FIG. 14 is a flow diagram of a process implemented by the facility for generating a web services definition language file for a composite application.

FIG. 15 is a block diagram that illustrates an example environment in which a data access service component of the facility functions.

FIG. 16 is a flow diagram of a process implemented by the facility for responding to requests for data received by the data access service component.

### DETAILED DESCRIPTION

A software and/or hardware facility for implementing composite applications is described herein. The facility includes a composite application designer that enables users to create and modify composite applications. A composite application can include data from primary assets, as well as data from derived assets, which are assets that are derived from one or more primary assets. The composite application designer also enables the creation of configuration files for configuring access to data corresponding to primary and derived assets. The facility also includes a data access service that enables access to data corresponding to primary and derived assets. The data access service is configured by a configuration file that is created by the composite application designer.

Various embodiments of the invention will now be described. The following description provides specific details for a thorough understanding and an enabling description of these embodiments. One skilled in the art will understand, however, that the invention may be practiced without many of these details. Additionally, some well-known structures or functions may not be shown or described in detail, so as to avoid unnecessarily obscuring the relevant description of the various embodiments. The terminology used in the description presented below is intended to be interpreted in its broadest reasonable manner, even though it is being used in conjunction with a detailed description of certain specific embodiments of the invention.

### 1. Overview of the Facility

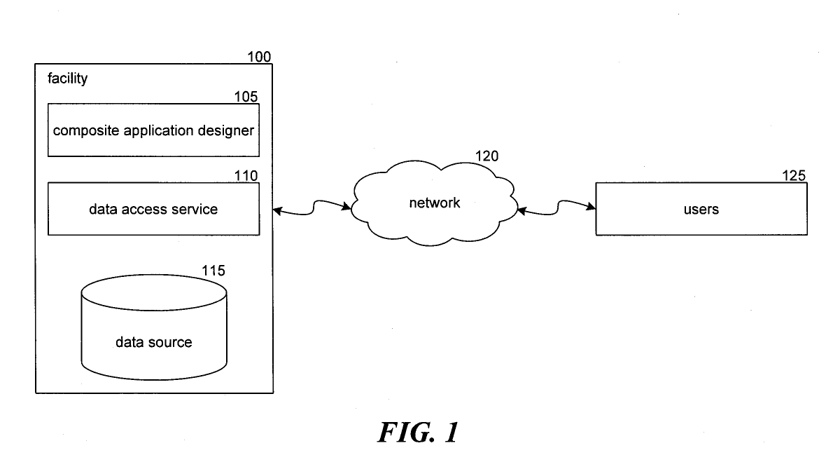

FIG. 1 is a block diagram illustrating components of a software and/or hardware facility 100 (“the facility”). The facility 100 includes various components to implement the functions described herein, including a composite application designer 105, a data access service 110 and a data source 115. The composite application designer 105 analyzes data stored in the data source 115 (and if necessary, other data sources), defines a composite application model and generates artifacts used to implement a composite application. The data access service 110 is a service that provides read and write access to data in the data source 115 to various web service clients. The data source 115 stores data. Users 125, which may be human users or computer processes, interact with the facility 100 over a network 120, such as the Internet. The network 120 can also include an intranet or other private or non-public network. For example, administrators of the facility may access the facility over a private, firewalled network that is only connected to a public network (e.g., the Internet) via a gateway device. Other entities (not shown) that may interact with the facility over, through or via the network 120 include routers, firewalls, application servers, database servers, other servers and client computing systems.

In some embodiments, the facility 100 is configured to interact with a application server such as Microsoft Office SharePoint Server (MOSS), and the data source 115 is a relational database, such as a Microsoft SQL Server database, an Oracle DBMS database, an IBM DB2 database, or a MySQL database. The facility 100 will be discussed throughout the remainder of this disclosure in the context of these embodiments. Those of skill in the art, however, will understand that the facility 100 may be configured to interact with various other application servers, and that the data source 115 may include data stored in both relational and non-relational structures. For example, the data source 115 may be an application-specific data source, such as those specific to the applications FileNet, Epicore or Cerner. As another example, the data source 115 may be a web service interface to a legacy application or an Extensible Markup Language (XML) file. In some embodiments, the data access service 110 is configured to interact with a Microsoft BizTalk Server. Those of skill in the art, however, will understand that the data access service 100 may be configured to interact with various other web services middleware products, such as those produced by Tibco, WebMethods, IBM and SeeBeyond. The data source 115 stores primary assets and derived assets. Where the data source 115 is a relational database, primary assets correspond to tables in the relational database. Primary assets may also correspond to other objects in the relational database, such as views, as well as other objects stored in non-relational data structures. Derived assets are derived from one or more primary assets.

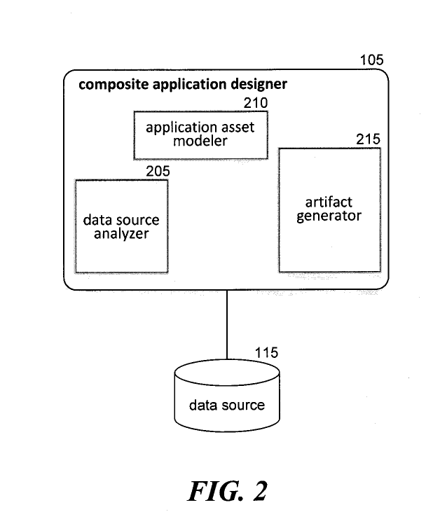

FIG. 2 is a block diagram that illustrates the composite application designer 105 in more detail. The composite application designer 105 is implemented as a Microsoft Windows®-based application, though it may be implemented partially or wholly as a web-based application that runs inside a web browser. The composite application designer 105 includes the following components: a data source analyzer 205, an application asset modeler 210 and an artifact generator 215. The data source analyzer 205 accesses the data stored in the data source 115 to extract metadata information about primary assets, associations between primary assets and methods of reading data from and writing data to the data source 115. For example, the data source 115 may be an order entry database containing Customer, Product and Order tables. The data source analyzer 205 would determine that these tables are primary assets and would determine the following metadata information about each table: the table columns, the data type of each column, the primary key (if it exists) of each table, and the foreign keys (if they exist) of each table. The data source analyzer 205 may also read Web Services Definition Language (WSDL) files to determine external sources of data and accordingly obtain data from these external sources of data.

The application asset modeler 210 enables a user to create derived assets from one or more primary assets. The user can then edit and/or delete derived assets. The artifact generator 215 generates configuration data based upon the primary assets and the derived assets. The artifact generator 215 generates the following configuration data: 1) a composite application model configuration file (e.g., a Business Data Catalog (BDC) configuration file, which is a configuration file for a Business Data Catalog of a MOSS); 2) a data access service 110 configuration file; 3) a forms component Extensible Markup Language Schema Definition (XSD) file (e.g., an InfoPath Server XSD file); 4) a Web Services Definition Language (WSDL) specification file for the data access service 110; 5) stored procedures files; and 6) configuration files for generating reports. The composite application model configuration file specifies a model for the composite application, including data structures for use in components of the composite application (e.g., MOSS lists and web parts), and also specifies derived assets so that they can be indexed for search purposes. The data access service 110 configuration file configures the data access service 110 by specifying stored procedures for reading data from and writing data to the data source 115. The XSD file enables a forms component of the application server (e.g., an InfoPath forms component of a MOSS) to access the data access service 110. The WSDL specification file specifies methods the data access service 110 provides to web services clients. The stored procedures files contain scripts for creating stored procedures that, when installed into the data source 115, enable the various components of the application server (e.g., via the BDC of MOSS) to read data from the data source 115, and the data access service 110 to read data from and write data to the data source 115. The configuration files for generating reports are a set of Microsoft SQL Server Report Model configuration files for generating reports using Microsoft SQL Server Analysis services.

### 2. Creating Composite Applications

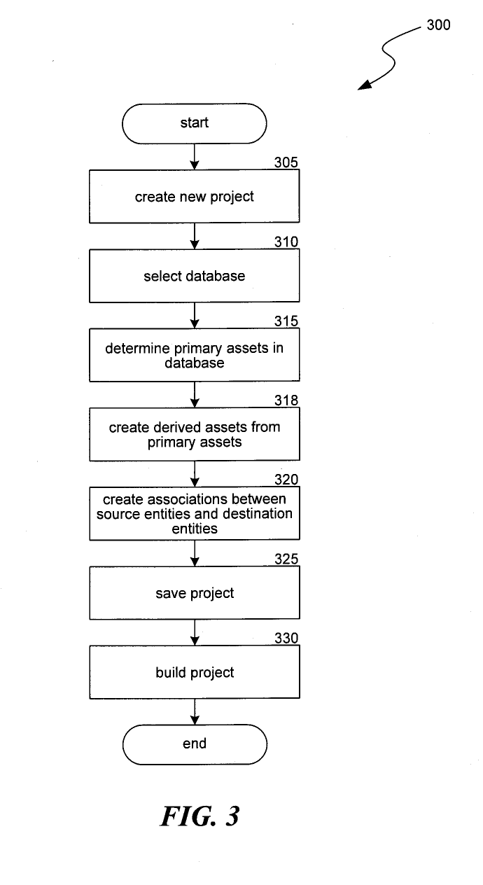

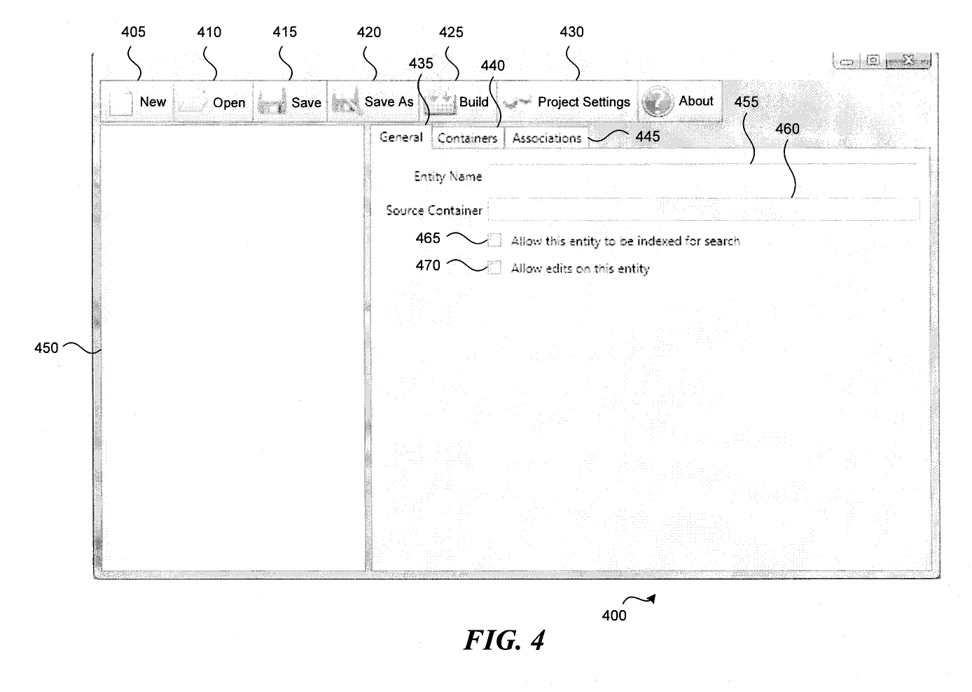

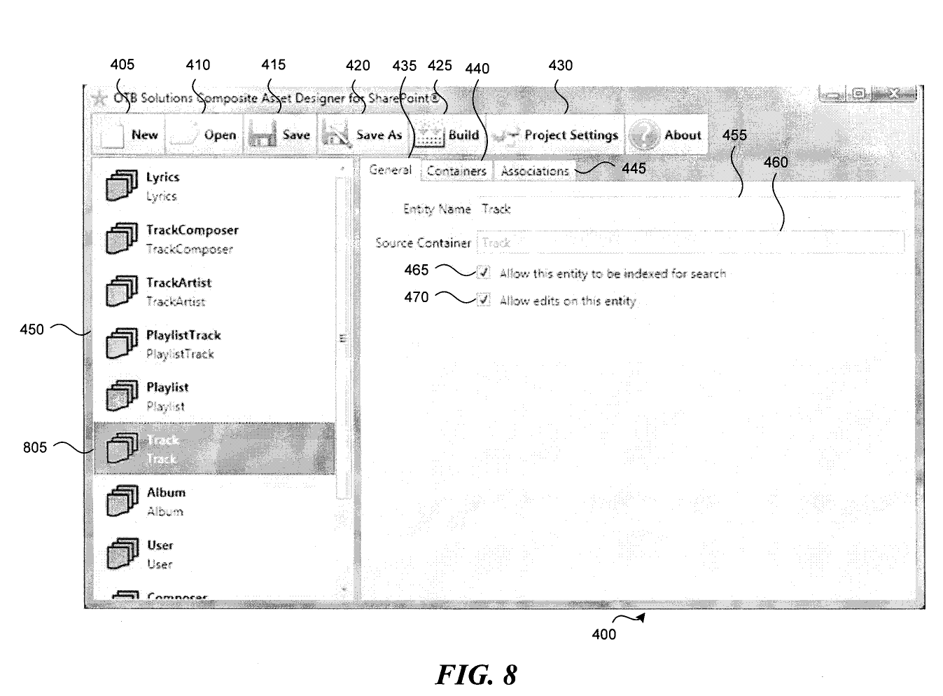

FIG. 3 is a flow diagram of a process 300 implemented by the facility for enabling a user to create a composite application. The process 300 begins at block 305 where a user creates a new project using the composite application designer 105. FIG. 4 is a representative screenshot depicting an interface 400 of the composite application designer 105 that is displayed when the user starts the composite application designer 105. The user creates a new project by selecting New button 405 or opens an existing project by selecting Open button 410. The user saves an open project by selecting Save button 415 or Save As button 420. The user builds an open project by selecting Build button 425. The user modifies the settings of an open project by selecting Project Settings button 430. The interface 400 includes a region 450 for displaying entities (described in more detail with reference to FIG. 8). The interface 400 also includes a tabbed display region containing a General tab 435, a Containers tab 440 and an Associations tab 445. The General tab 435 includes an editable text box 455 for displaying and editing an entity name and a non-editable text box 460 for displaying a source container name of the entity. The General tab 435 also includes two check boxes 465 and 470, which enable or disable indexing for an entity for search purposes and for allowing edits on an entity, respectively.

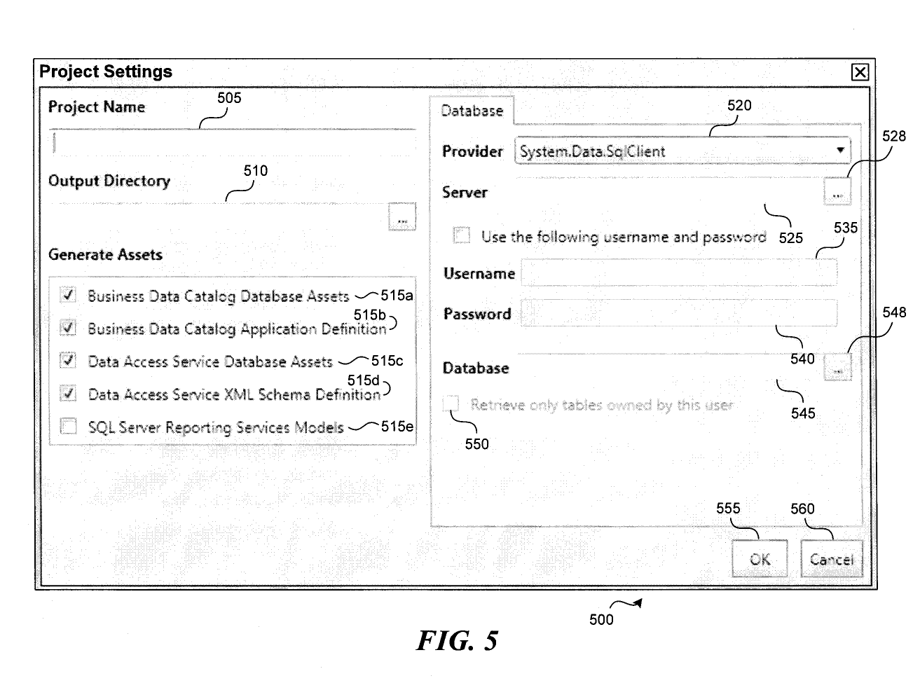

FIG. 5 is a representative screenshot depicting an interface 500 of the composite application designer 105 that is displayed when the user creates a new project, such as by selecting the New button 405 of FIG. 4. The interface 500 includes a Project Name text box 505 for providing a project name and an Output Directory text box 510 for providing an output directory for project build files. The interface 500 also includes a region having check boxes 515a-e, which enable or disable the generation of the previously-discussed artifacts by the artifact generator 215. The interface 500 also includes a Provider select box 520 for selecting a data provider; and a Server text box 525 for specifying a server (e.g., the database server). Alternately, the user can select a server by selecting button 528, which causes the composite application designer 105 to discover servers (e.g., database servers). The user can also specify a username and password for accessing the data source 115 in Username and Password text boxes 535 and 540, respectively. The interface 500 also includes a Database text box 545 for specifying a database (i.e., the data source 115). Alternately, the user can select a server by selecting button 548, which causes the composite application designer 105 to discover databases on an already specified server. The user can also specify that only tables owned by the user are to be retrieved by selecting check box 550. The user selects OK button 555 when finished configuring the project or Cancel button 560 to cancel the configurations made.

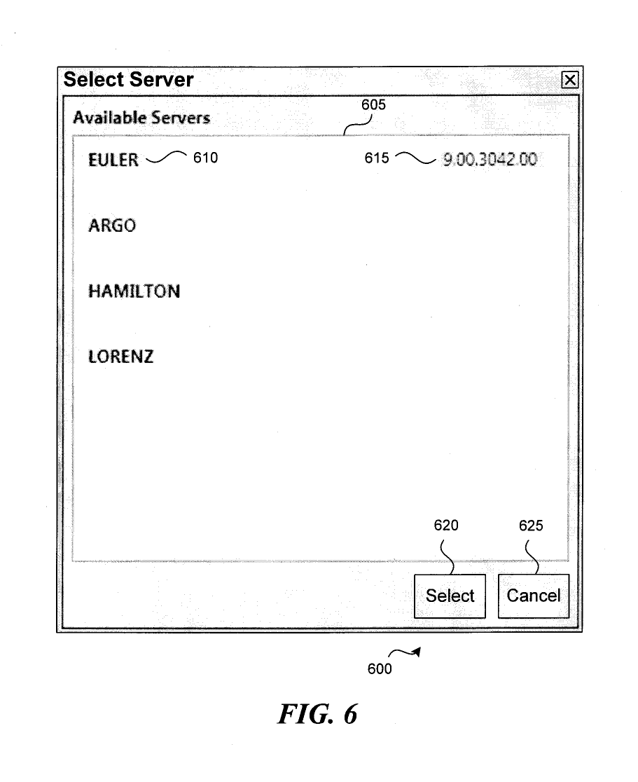

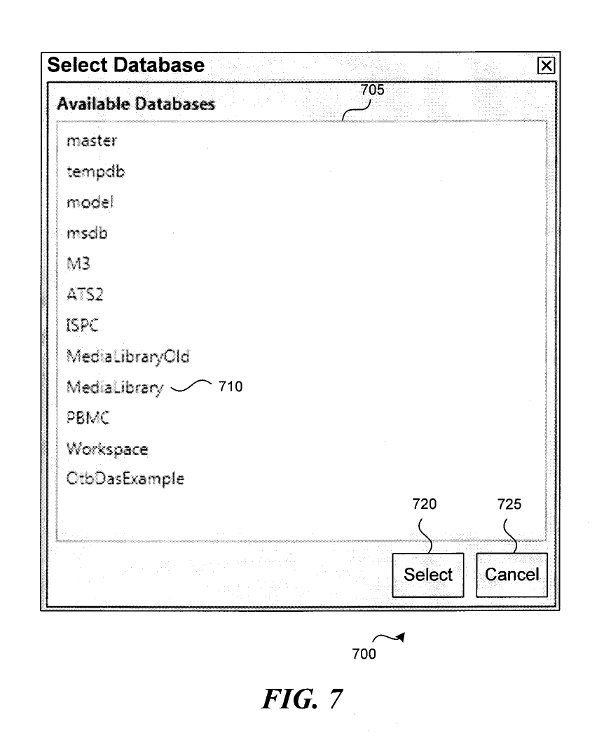

Returning to FIG. 3, the process 300 continues at block 310 where the user selects a data source 115. FIG. 6 is a representative screenshot depicting an interface 600 for selecting a server that is displayed when the user clicks on button 528 of FIG. 5. The interface 600 includes a region 605 enumerating database servers that the composite application designer 105 discovered. The available database servers include server “Euler” 610, which is a Microsoft SQL Server database server; the version 615 of the database server is also displayed in region 605. The user selects a database server and then selects button 620 or cancels by selecting button 625. FIG. 7 is a representative screenshot depicting an interface 700 for selecting a database that is displayed when the user clicks on button 548 of FIG. 5. The interface 700 includes a region 705 enumerating databases 115 that the composite application designer 105 discovered on the server selected in FIG. 6. The available databases 115 include database MediaLibrary 710. The user selects a data source 115 and then selects button 720 or cancels by selecting button 725. The composite application designer 105 then opens a connection to the database. The composite application designer 105 then determines the tables, keys, views and indexes in the data source 115.

Returning to FIG. 3, the process 300 continues at block 315 where the composite application designer 105 identifies primary assets in the data source 115. As previously noted, where the data source 115 is a relational database, the primary assets are tables in the database. Each table is a container for an entity. An entity is a business object in a composite application. An instance of an entity is a row in the table corresponding to the entity. When analyzing a database, the composite application designer 105 identifies each table in the databaseas an entity. For example, for a composite application that includes an order-entry aspect having Customer and Product entities, there are Customer and Product tables in the database that are Customer and Product containers for the Customer and Product entities, respectively. Instances of a Customer entity and instances of a Product entity are rows in the Customer and Product tables, respectively. In some embodiments, an entity has a container that is an object other than a table (e.g., a view) in the data source 115, or a container that is data from a legacy application (e.g., data from a ERP, SCM or CRM application obtained via web services). The composite application designer 105 also determines the following metadata about each table: the table columns, the data type of each table column, the primary key (if it exists), and any foreign keys. FIG. 8 is a representative screenshot depicting the interface 400 displaying entities from a media library composite application in region 450 that the composite application designer 105 has determined from the tables in the data source 115. A Track entity 805 (having a container that is a Track table in the data source 115) has been selected. The editable entity name Track is displayed in text box 455, and the non-editable source container name Track is displayed in text box 460. Check boxes 465 and 470 have been selected to allow the Track entity to be indexed for search and to allow it to be edited.

Returning to FIG. 3, the process 300 continues at block 318 where the user creates derived assets from primary assets. As previously noted, a derived asset is derived from one or more primary assets. For example, consider a media library composite application having Track, Artist and TrackArtist entities (and corresponding Track, Artist and TrackArtist tables that are containers for the entities). Assume that the Track, Artist and TrackArtist tables are normalized, and that the TrackArtist table enables many-to-many relationships between rows in the Track table and rows in the Artist table (i.e., the TrackArtist table has columns that are foreign keys to the primary keys of the Track and Artist tables). The composite application designer 105 would determine that TrackArtist is an entity. It may be desirable to enable an instance of the TrackArtist entity to return data stored in the Artist table when the instance is retrieved. The composite application designer 105 enables a user to modify the TrackArtist entity so as to draw data from both the TrackArtist and Artist tables (i.e, to create a derived asset).

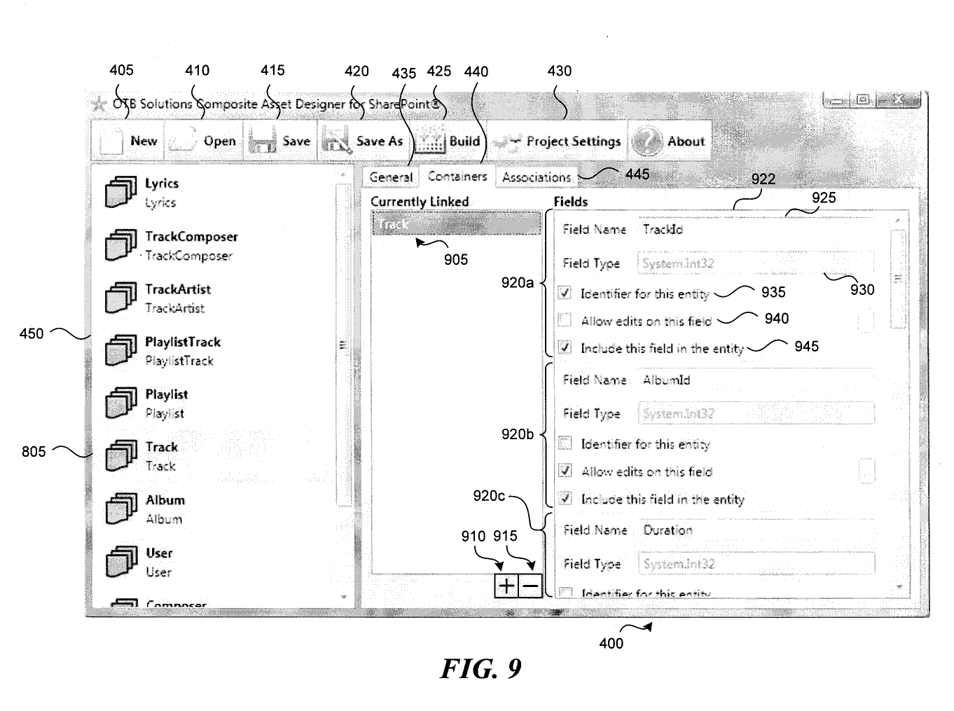

FIG. 9 is a representative screenshot depicting the interface 400 having the Containers tab 440 selected, which enables the creation of a derived asset. The Containers tab 440 lists the container of the selected entity. Track entity 805 is selected and its Track container 905 is shown. The details of the fields of the Track container 905 (i.e., the Track table) are shown in region 922. Information about a first field of the Track table, TrackId, is shown in region 920a. This information, which was previously determined by the composite application designer 105, includes the following: the Field Name TrackId, shown in editable text box 925; field type System.Int32, shown in non-editable text box 930; a check box 935 for specifying that the field is an identifier for the Track entity; a check box 940 for allowing edits on this field; and a check box 945 for including this field in the entity. In some embodiments, if a user edits the Field Name in editable text box 925, the composite application designer 105 updates the data source 115. The check box 935 is checked for the field TrackId, indicating that this field is the primary key for the Track entity, which was determined by the composite application designer 105. The check box 940 is not checked for the field TrackId, indicating that this field is not to be edited (i.e., the TrackId value of an entry in the Track table cannot be edited). The check box 945 is checked for the field TrackId, indicating that this field is to be included in the entity. Other information about fields AlbumId and Duration are shown in regions 920b and 920c, respectively. The user can link a new container to the selected entity by selecting button 910 (which brings up an interface, not depicted in the Figures for selecting a table in the database) or delete an existing container by selecting button 915. By linking a new container to the selected entity, the user creates a derived asset, and the user can specify which fields from both containers are to be part of the selected entity. Therefore, the interface 400 displayed in FIG. 9 enables a user to create or modify an entity, link it to one or more containers (each of which is a table) and determine which of the table fields is to be the identifier for the entity, which table fields are to be included in the entity, and which table fields are allowed to be edited. The user can therefore create derived assets by adding or deleting containers using buttons 910 or 915.

Where the data source 115 is a web service, the composite application designer 105 retrieves the web service's WSDL file and creates the primary assets from the WSDL file. A user can then modify the primary assets to create derived assets, which are not necessarily returned directly by the web service. For example consider the pseudo code for a web service shown in Table 1 below:

TABLE 1
1 public class WebService {

| | |
|---|---|
| 2 | public PrimaryAsset GetServiceMethod (int id) |
| 3 | { |

| | |
|---|---|
| 4 | PrimaryAsset result = new PrimaryAsset ( ); |
| 5 | ... do some work ... |
| 6 | return result; |

| | |
|---|---|
| 7 | } |
| 8 } | |

9 public class DerivedAsset {

| | |
|---|---|
| 10 | public string Field1; |

| | |
|---|---|
| 11 | public string Field2; |

| | |
|---|---|
| 12 | } |
| 13 | public class PrimaryAsset { |

| | |
|---|---|
| 14 | public DerivedAsset[ ] ContainedAsset; |
| 15 | public string Name; |
| 16 | public string Value; |
| 17 } | |

The web service returns only one object type (PrimaryAsset) but the composite application designer 105 enables the ability to also create an entity based using DerivedAsset (which is returned as a result of the call to GetServiceMethod).

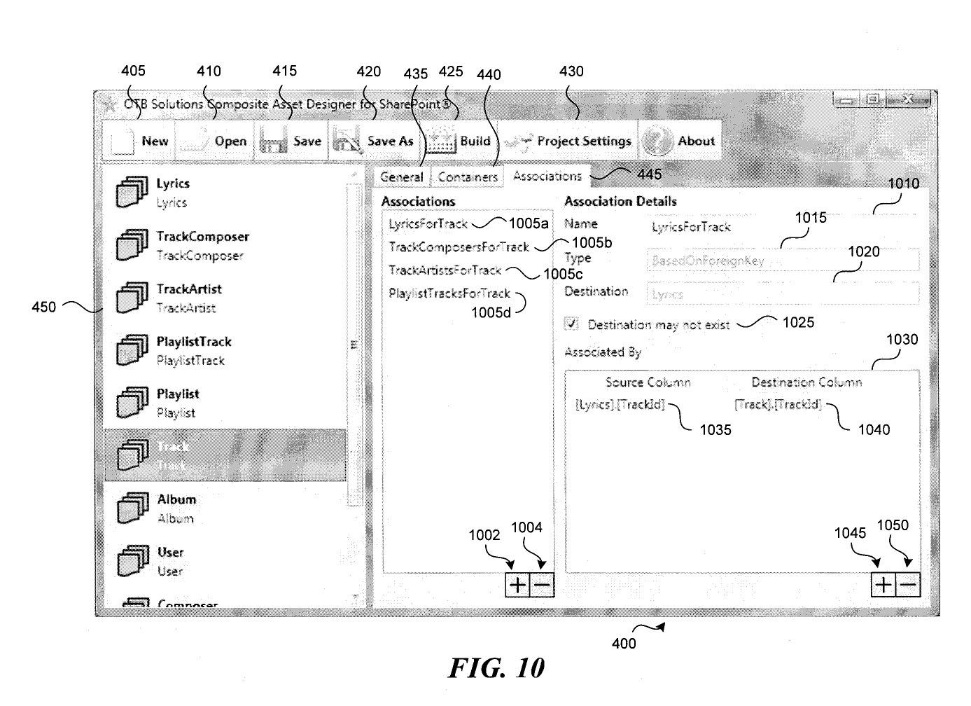

Returning to FIG. 3, the process 300 continues at block 320 where the user creates or modifies associations between entities. FIG. 10 is a representative screenshot depicting the interface 400 having the associations tab 445 selected. Associations 1005a-d are displayed. The composite application designer 105 determines associations based upon foreign keys of the tables in the data source 115. However, if there are no foreign keys in the tables, the user can create associations to associate two or more entities. An association is created between one or more source entities and a destination entity. The user can add a new association by selecting button 1002 or delete an existing association by selecting button 1004. Association 1005a is selected, and details of the association are displayed. These details include an editable name of the association shown in text box 1010, a non-editable type of the association shown in text box 1015, and a non-editable destination of the association shown in text box 1020. Because this association was based upon a foreign key in the Lyrics table, the type is BasedOnForeignKey shown in text box 1015, and it is not editable. If the association was user-created (i.e., created by selecting button 1002), the type shown in text box 1015 would still not be editable, but it would be UserGenerated, and the destination would be editable. The user can specify that the destination may not exist by selecting check box 1025. Region 1030 displays how the source entity is associated with the destination entity. As shown, the source column is [Lyrics].[TrackId] 1035 and the destination column is [Track].[TrackId] 1040. The user can delete how the source entity is associated with the destination entity by selecting button 1050 or can add new information as to how the source entity is associated with the destination entity by selecting button 1045.

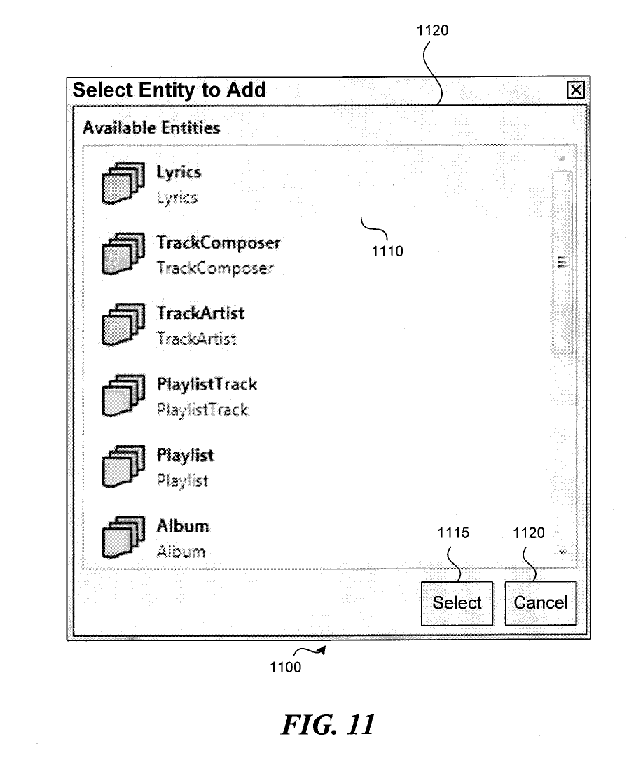

FIG. 11 is a representative screenshot depicting an interface 1100 of the composite application designer 105 that is displayed to the user for selecting a destination entity. The source entity has already been selected. The interface 1100 is displayed to the user when the user creates a new association using the interface depicted in FIG. 10 and adds a destination by selecting a button (not shown in FIG. 10). The interface 1100 includes a region 1120 enumerating available destination entities in the data source 115. As shown, the destination entity Lyrics 1110 has been selected. The user selects Select button 1115 when finished selecting a destination entity or Cancel button 1120 to cancel the selection of a destination entity.

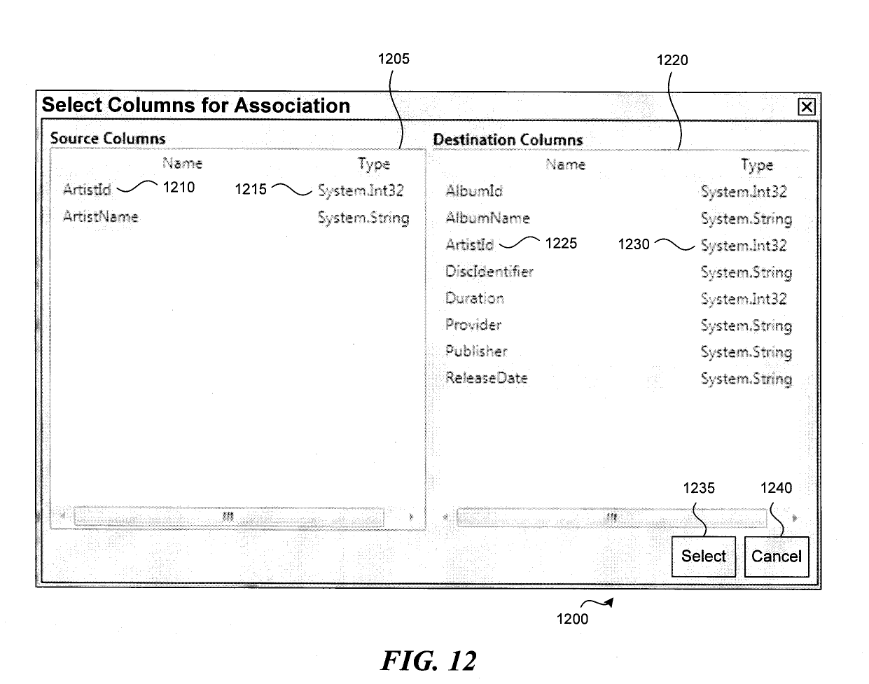

FIG. 12 is a representative screenshot depicting an interface 1200 of the composite application designer 105 that is displayed to the user for selecting columns of tables for associations after selecting the button 1045 of FIG. 10. The interface 1200 includes a source columns region 1205 listing available source columns of the source table and a destination columns region 1220 listing available destination columns of the destination table. The source columns region 1205 lists the ArtistId column 1210 and its type 1215. The destination columns region 1220 lists the ArtistId column 1225 and its type 1230. The user selects Select button 1235 when finished selecting source and destination columns or cancel button 1240 to cancel the selections made.

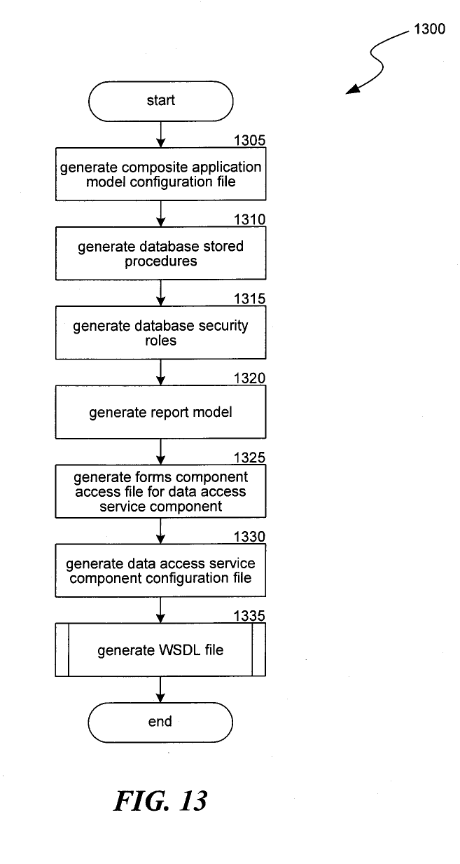

Returning to FIG. 3, the process 300 continues at block 325 where the user saves the project, and at block 330, where the user builds the project. FIG. 13 is a flow diagram of a process 1300 for building the project by generating artifacts for the composite application. An artifact is a file. The process 1300 begins at block 1305 where the artifact generator 215 generates the composite application model configuration file (e.g., the BDC configuration file). The composite application model configuration file contains information about the data source 115 and information about entities in the composite application. For example, consider a media library composite application that has the following entities: PlaylistTrack, TrackEntity, Lyrics, TrackComposer, Playlist, Album, User, Composer, Artist and TrackArtist. The composite application model configuration file has information about each of these entities, each of which was previously created using the composite application designer 105. The TrackArtist entity has two associated containers: an Artist table that contains listing of artists, and a TrackArtist table that enables many-to-many relationships between tracks and artists (i.e., the TrackArtist is a derived asset created by the composite application designer 105). The composite application model configuration file also contains information about identifiers and methods for accessing data corresponding to the entities for each entity. A portion of a sample composite application model configuration file pertaining to the TrackArtist entity is shown in Table 2 below.

TABLE 2
1 <Entity EstimatedInstanceCount=“10000” Name=“TrackArtist”>

| | |
|---|---|
| 2 | <Identifiers> |

| 3 | <Identifier TypeName=“System.Int32” |
|---|---|
| | Name=“TrackId” /> |
| 4 | <Identifier TypeName=“System.Int32” |
| | Name=“ArtistId” /> |

| | |
|---|---|
| 5 | </Identifiers> |

| | |
|---|---|
| 6 | <Methods> |

| | |
|---|---|
| 7 | <Method Name=“GetTheTrackArtist”> |
| 8 | <Method Name=“GetAllTrackArtist”> |
| 9 | <Method Name=“GetArtistsForTrackArtist”> |

| | |
|---|---|
| 10 | </Methods> |

| | |
|---|---|
| 11 | </Entity> |

The TrackArtist entity has several associated methods: GetTheArtist, for getting data about the artist name for a specific artist for a specific track; GetAllArtist, for getting data about all artists for all tracks; and GetArtistsForTrackArtist, for getting data about an artist for a specific artist. For each method, there is an associated stored procedure that when executed, returns the appropriate data from the data source 115. The composite application model configuration file also has information about associations between entities that were created using the composite application designer 105. Continuing with the previous example, there is an association between TrackArtist and Artist. The composite application model configuration file has information about this association, such as the source entity (TrackArtist), the destination entity (Artist) and the associated method (GetArtistsForTrackArtist). A portion of a sample composite application model configuration file pertaining to the TrackArtist entity is shown in Table 3 below.

TABLE 3

| 1 <Associations> | |
|---|---|
| 2 | <Association AssociationMethodEntityName=“TrackArtist” |

| | |
|---|---|
| 3 | AssociationMethodName=“GetArtistsForTrackArtist” |
| 4 | AssociationMethodReturnParameterName=“Artist” |
| 5 | Name=“ArtistForTrackArtist” IsCached=“true”> |

| | |
|---|---|
| 6 | <SourceEntity Name=“TrackArtist” /> |
| 7 | <DestinationEntity Name=“Artist” /> |
| 8 | </Association> |

9 </Associations>

At block 1310 the artifact generator 215 generates database stored procedures and writes scripts for creating the stored procedures in one or more files. The artifact generator 215 generates two files containing scripts for creating stored procedures. The first file contains scripts for creating stored procedures that are associated with the methods in the composite application model configuration file. Continuing with the example of the preceding paragraph, the GetTheArtist method has an associated stored procedure named prc_TRACKARTIST_Select, the GetAllArtist method has an associated stored procedure named prc_TRACKARTIST_GetAll, and the GetArtistsForTrackArtist has an associated stored procedure named prc_TRACKARTIST_GetArtists. The stored procedures contain the Structured Query Language (SQL) code for obtaining data from the tables in the data source 115. The second file contains scripts for creating stored procedures for enabling write access to the data in the data source 115. Continuing with the example of the preceding paragraph, the TrackEntity entity has stored procedures for inserting, updating and deleting data stored in the table to which it is mapped (the Track table). As another example, the TrackArtist entity has a stored procedure for deleting data stored in the tables to which it is mapped—the TrackArtist and the Artist tables. Where the data source 115 is a web service, the artifact generator 215 does not create stored procedures.

At block 1315 the artifact generator 215 generates database security roles and writes them in one or more script files. At block 1320 the artifact generator 215 generates report model files. At block 1325 the artifact generator 215 generates the forms component XSD file (e.g., the InfoPaths access file) that enables the forms component to read data from and write data to the data source 115 via the data access service 110. The forms component XSD file that contains elements with attributes that specify methods for inserting, updating and deleting data stored in the data source 115. For example, for an albumInsert method, a portion of a sample forms component XSD is shown in Table 4 below. Elements pertaining to parameters other than albumName are omitted for brevity.

TABLE 4

| 1 <xs:element name=“albumInsert”> | |
|---|---|
| 2 | <xs:complexType> |
| 3 | <xs:sequence> |
| 4 | <xs:element name=“albumName”> |

| | |
|---|---|
| 5 | <xs:simpleType> |
| 6 | <xs:restriction base=“xs:string”> |
| 7 | <xs:minLength value=“1” /> |
| 8 | <xs:maxLength value=“512” /> |
| 9 | </xs:restriction> |
| 10 | </xs:simpleType> |

| | |
|---|---|
| 11 | </xs:element> |
| 12 | ... |
| 13 | </xs:sequence> |
| 14 | </xs:complexType> |

| | |
|---|---|
| 15 | </xs:element> |

At block 1330 the artifact generator 215 generates the configuration file for the data access service 110. The configuration for the data access service 110 contains elements that map the methods for inserting, updating and deleting data stored in the data source 115 specified in the InfoPaths access file to the stored procedures specified in the second script file described in the previous paragraph. The configuration file for the data access service 110 also contains elements that map the methods for getting data from the data source 115 specified in the composite application model configuration file to stored procedures. A portion of a sample composite application model configuration file pertaining to the albumInsert method is shown in Table 5 below.

TABLE 5
1 <AssetOperation name=“albumInsert”>

| 2 | <Text>prc_ALBUM_Insert</Text> |
|---|---|
| 3 | <Connection> |
| 4 | <Provider>SYSTEM.DATA.SQLCLIENT</Provider> |
| 5 | <String>Data Source=sandbox.kdsa.local; Initial |
| 6 | Catalog=MediaLibraryNoKeys; Integrated Security=true; |
| | User ID=; |
| 7 | Password=</String> |
| 8 | </Connection> |
| 9 | <Parameters> |

| 10 | <OperationParameter name=“AlbumName” |
|---|---|
| | type=“System.String”/> |
| 11 | <OperationParameter name=“ArtistId” |
| | type=“System.Int32”/> |
| 12 | <OperationParameter name=“DiscIdentifier” |
| | type=“System.String”/> |
| 13 | <OperationParameter name=“Duration” |
| | type=“System.Int32”/> |
| 14 | <OperationParameter name=“Provider” |
| | type=“System.String”/> |
| 15 | <OperationParameter name=“Publisher” |
| | type=“System.String”/> |
| 16 | <OperationParameter name=“ReleaseDate” |
| | type=“System.String”/> |

| | |
|---|---|
| 17 | </Parameters> |

| | |
|---|---|
| 18 | </AssetOperation> |

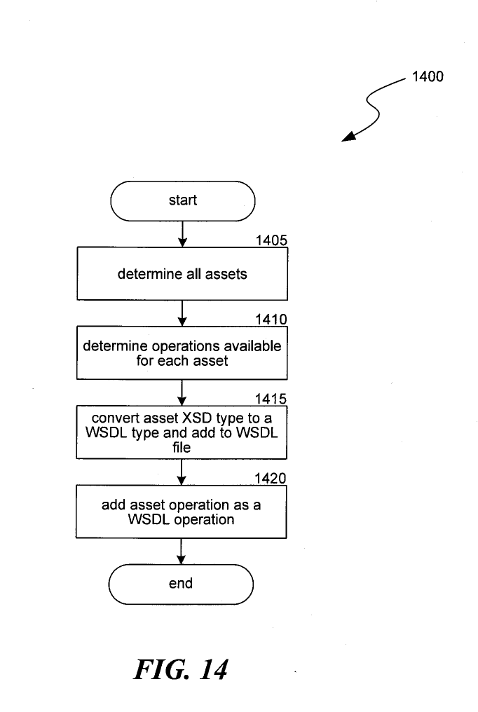

At block 1335 the artifact generator 215 generates the WSDL file, the process for which is described with reference to FIG. 14. FIG. 14 is a flow diagram of a process 1400 implemented by the facility for generating the WSDL file. At block 1405 the artifact generator 215 determines all assets, both primary and derived. At block 1410 the artifact generator 215 determines the operations (e.g., get, insert, update and delete operations) that are available for each asset. At block 1415 the artifact generator 215 converts the asset XSD type to a WSDL type and adds it to the types section of the WSDL file. At block 1420 the artifact generator 215 adds the asset operation as a WSDL-compatible operation. The process 1400 then ends. The WSDL file contains elements specifying the WSDL-compatible operations that are exposed to web services clients: Update, Select and SelectEx, and the WSDL-compatible return operations: UpdateResponse, SelectResponse and SelectExResponse. The conclusion of the process 1400 ends the process 1300, thus ending the process 300.

The files generated by the artifact generator 215 are manually installed into the appropriate areas by an administrator or other user with the appropriate permissions. For example, the stored procedures are manually installed by an administrator or other user with the appropriate permissions by executing the script files containing them against the data source 115, thus creating the stored procedures. Alternatively, the artifact generator 215 can automatically install the stored procedures by executing the script files against the data source 115. As another example, the database security roles are installed into the data source 115 manually by an administrator or other user with the appropriate permissions. Alternatively, the artifact generator 215 can automatically install the database security roles by executing the script files containing them against the data source 115. As a final example, the InfoPaths access file is manually installed into an application server (e.g., MOSS) by an administrator or other user with the appropriate permissions. Alternatively, the artifact generator 215 can automatically install the forms component access file into an application server (e.g. MOSS). The other files (e.g., the report model files, the WSDL file) are manually installed but can also be automatically installed by the artifact generator 215.

One advantage of using the composite application designer 110 to generate configuration files is that it keeps the configuration data synchronized whenever there are changes to the underlying data, such as changes to entities. Another advantage of the composite application designer 110 is that it can generate configuration data that enable read and write access to a variety of application server components, such as a form automation component that presents a user interface and validates and captures user-entered data, a search component that enables the indexing and retrieval of data (e.g., instances of entities) and components that connect to external data sources (e.g., legacy ERP, SCM or CRM applications). The composite application designer 110 generates an application model configuration file that ensures consistent access to data.

### 3. Data Access Service Component

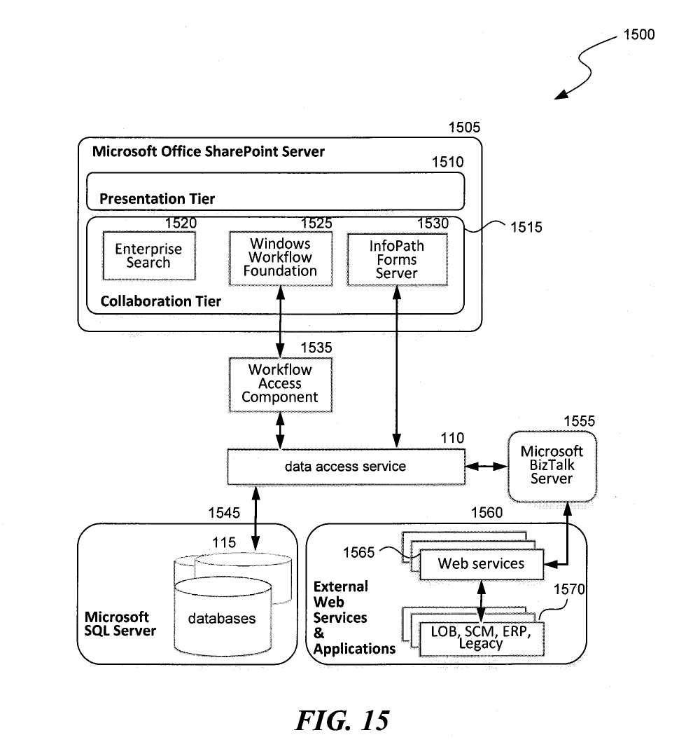

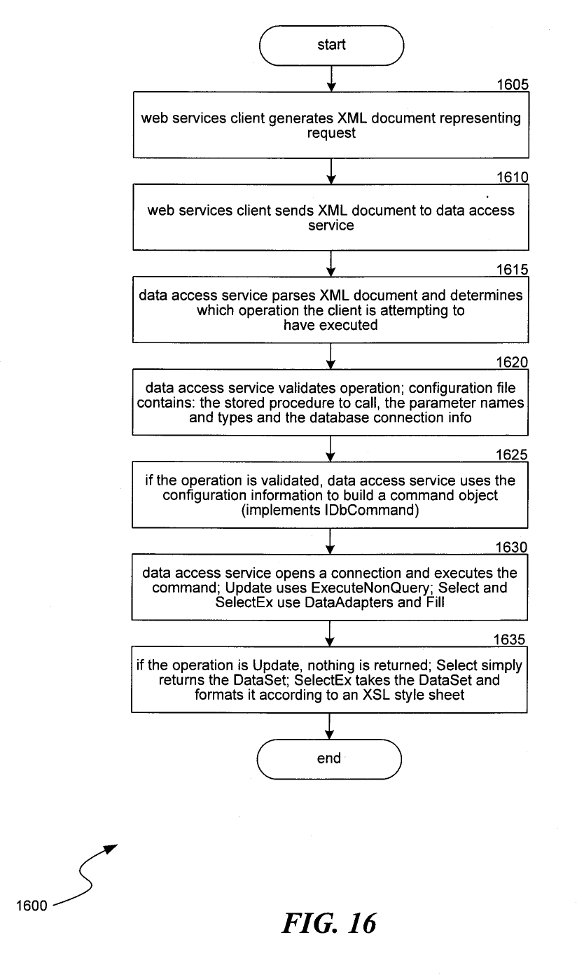

FIG. 15 is a block diagram that illustrates an example environment 1500 in which the data access service 110 functions. The environment 1500 includes a MOSS 1505, which has a Presentation Tier 1510 and a Collaboration Tier 1515. The Collaboration Tier 1515 includes an Enterprise Search component 1520, a Windows Workflow Foundation component 1525, and an InfoPath Forms Server 1530. The Windows Workflow Foundation component 1525 interacts with a Workflow Access component 1535, which interacts with the data access service 110. The InfoPaths Forms Server 1530 interacts with the data access service 110. External web services and applications 1560, such as web services 1565 and Line of Business (LOB), Supply Chain Management (SCM) and Enterprise Resource Planning (ERP) applications 1570 interact with a Microsoft BizTalk Server 1555, which interacts with the data access service 110. The data access service 110 provides read and write access to data stored in Microsoft SQL Server 1545 databases 115 to all of the components with which it interacts. As previously described, the access to data in the databases 115 that the data access service 110 provides is determined by the information in the data access service 110 configuration file generated by the artifact generator 215. The data access service 110 is configured as a web service. As described in more detail with reference to FIG. 16, the other components illustrated in FIG. 15 communicate with the data access service 110 using a Simple Object Access Protocol (SOAP) 1. protocol (e.g., SOAP 1.1, although other versions of SOAP may be supported as well). The other components send SOAP 1.x-compatible XML documents to the data access service 110 over an HTTP-based communication channel (an HTTPS-based communication channel may also be used).

FIG. 16 is a flow diagram of a process 1600 implemented by the facility 100 for responding to requests for data received by the data access service 110. The process 1600 begins at block 1605 where a web services client (e.g., the Workflow Access Component 1535, the InfoPath Forms Server 1530 or the Microsoft BizTalk Server 1555) generates an XML document that represents the request for data. The XML document is structured to comply with the SOAP 1.x protocol, and contains the operation (either Select, SelectEx or Update) that the web services client wishes to have the data access service 110 execute. Continuing with the media library example of preceding paragraphs, if the web services client is attempting to have an operation to create a new instance of an Album entity (equivalent to inserting a new row into the Album table, which corresponds to the Album entity) the SOAP 1.x-compatible XML document would contain an element specifying an Update operation in the body of the SOAP message, and an element having a string value that specifies the method for creating a new Album entity instance (i.e., the method albumInsert) and the parameters (i.e., the parameters albumName, artistid, discIdentifier, duration, provider, publisher and releaseDate) and values for the parameters. A portion of a sample SOAP 1.x-compatible XML document pertaining to the albumInsert method is shown in Table 6 below.

```
TABLE 6
  1 <?xml version=“1.0” encoding=“utf-8” ?>
  2 <soap:Envelope xmlns:xsi=http://www.w3.org/2001/XMLSchema-instance
```

| | |
|---|---|
| 3 | xmlns:xsd=http://www.w3.org/2001/XMLSchema |
| 4 | xmlns:soap=“http://schemas.xmlsoap.org/soap/envelope/”> |

5 <soap:Body>

| | |
|---|---|
| 6 | <Update xmlns=“http://schemas.otbworkplace.com/service/dataaccess”> |

| | |
|---|---|
| 7 | <data><![CDATA[<albumInsert> |

| | |
|---|---|
| 8 | <albumName>My Test Album</albumName> |
| 9 | <artistId>1</artistId> |
| 10 | <discIdentifier>string-identifier</discIdentifier> |
| 11 | <duration>5</duration> |
| 12 | <provider>Provider Name</provider> |
| 13 | <publisher>Publisher</publisher> |
| 14 | <releaseDate>2007</releaseDate> |

| | |
|---|---|
| 15 | </albumInsert>]]></data> |

| | |
|---|---|
| 16 | </Update> |

| | |
|---|---|
| 17 | </soap:Body> |
| 18 | </soap:Envelope> |

At block 1610 the web services client sends the XML document to the data access service 110. At block 1615 the data access service 110 parses the XML document and determines which operation the web services client is attempting to have executed. In this example, the data access service 110 would determine that the web services client is attempting to create a new Album entity instance. At block 1620 the data access service 110 validates the operation to ensure that it may be executed. To do so, the data access service 110 reads the information in the data access service 110 configuration file, which contains the stored procedure to call (e.g., prc_ALBUM_Insert) and the parameter names and types to pass to the stored procedure. The data access service 110 configuration file also contains connection info for the data source 115, and the data access service 110 uses this connection info to create a connection to the data source 115.

At block 1625, if the data access service 110 is able to validate the requested operation, the data access service 110 uses the information in its configuration file to build a Command object, which is a .NET command object for executing a stored procedure. At block 1630 the data access service 110 opens a connection to the data source 115 and executes the operation. An Update operation uses the ExecuteNonQuery method, Select and SelectEx operations use DataAdapters and Fill. At block 1635, if the operation is Update, the data access service 110 returns nothing. If the operation is Select, the data access service 110 returns the DataSet. If the operation is SelectEx, the data access service 110 takes a DataSet and formats it according to an XSL style sheet. This allows the data access service 110 to return data according to the desired format of the web services client. Although the process 1600 is described using stored procedures to read, insert, update and delete data, those of skill in the art will understand that other methods of reading, inserting, updating and deleting data may be used, such as native SQL commands (e.g., SELECT, INSERT INTO, UPDATE, DELETE FROM, etc.). Furthermore, although the process 1600 is described using a .NET framework to access the data source 115, those of skill in the art will understand that other methods, protocols and application programming interfaces for accessing data may be used by the facility 100.

### 4. Conclusion

The foregoing description details certain embodiments of the invention. It will be appreciated, however, that no matter how detailed the foregoing appears in text, the invention can be practiced in many ways. For example the facility can be implemented as a distributed computing system, with components of the facility being implemented and/or executed on disparate systems that are connected over a network. The facility could equally well be executed as a standalone system. Moreover, the facility may utilize third-party services and data to implement all or portions of its functionality. Although the subject matter has been described in language specific to structural features and/or methodological steps, it is to be understood that the subject matter defined in the claims is not necessarily limited to the specific features or steps described. Rather, the specific features and steps are disclosed as preferred forms of implementing the claimed subject matter.

The above Detailed Description of embodiments of the invention is not intended to be exhaustive or to limit the invention to the precise forms disclosed. While various embodiments are described in terms of the environment described above, those skilled in the art will appreciate that various changes to the facility may be made without departing from the scope of the invention. For example, various embodiments are described in the context of application servers such as Microsoft Office SharePoint Server. Those skilled in the art will understand that the facility 100 may interact with various other application servers and components of application servers. As another example, those skilled in the art will appreciate that the actual implementation of the data source 115 may take a variety of forms. The term “data source” is used herein in the generic sense to refer to any data structure that allows data to be stored and accessed, such as databases, tables, linked lists, arrays, etc. As another example, while processes or blocks are presented in a given order, alternative embodiments may perform routines having steps, or employ systems having blocks, in a different order, and some processes or blocks may be deleted, moved, added, subdivided, combined, and/or modified to provide alternatives or subcombinations. Each of these processes or blocks may be implemented in a variety of different ways. Also, while processes or blocks are at times shown as being performed in series, these processes or blocks may instead be performed in parallel, or may be performed at different times.

These and other changes can be made to the invention in light of the above Detailed Description. Accordingly, the actual scope of the invention encompasses not only the disclosed embodiments, but also all equivalent ways of practicing or implementing the invention under the final claims.

I/We claim:

1. A system to create configuration data for a composite application to access derived assets that are maintained by one or more data sources, the system comprising:
an extraction component that accesses a plurality of primary assets that are maintained by one or more data sources and extracts metadata about the maintained plurality of primary assets;
a modeling component that allows a derived asset to be created by:
displaying the extracted metadata about the plurality of primary assets to a user;
receiving a selection from the user of two or more of the plurality of primary assets; and
storing a relationship creating a derived asset from the selected two or more primary assets; and
a configuration component that accesses the stored relationship, generates a process for accessing the two or more primary assets to create the derived asset, and outputs the process as configuration data for a composite application.

2. The system of claim 1, wherein at least one of the data sources is a database.

3. The system of claim 1, wherein at least one of the data sources is a web service.
